(19) United States
(12) Patent Application Publication
(10) Pub. No.: US 2012/0107683 A1
(43) Pub. Date: May 3, 2012

(54) COMPOSITES OF SELF-ASSEMBLED ELECTRODE ACTIVE MATERIAL-CARBON NANOTUBE, FABRICATION METHOD THEREOF AND SECONDARY BATTERY COMPRISING THE SAME

(75) Inventors: Il Doo KIM, Seoul (KR); Jin Hoon CHOI, Seoul (KR)

(73) Assignee: KOREA INSTITUTE OF SCIENCE AND TECHNOLOGY, Seoul (KR)

(21) Appl. No.: 13/277,440

(22) Filed: Oct. 20, 2011

(30) Foreign Application Priority Data
Oct. 27, 2010 (KR) 10-2010-0105389

(51) Int. Cl. H01M 4/58; H01B 1/02; H01M 4/64; H01B 1/04; B82Y 30/00

(52) U.S. Cl. 429/211; 429/231.8; 252/502; 252/503; 252/507; 252/509; 252/506; 252/508; 427/122; 977/742; 977/773

(57) ABSTRACT

A composite of electrode active material including aggregates formed by self-assembly of electrode active material nanoparticles and carbon nanotubes, and a fabrication method thereof are disclosed. This composite is in the form of a network in which at least some of the carbon nanotubes connect two or more aggregates that are not directly contacting each other, creating an entangled structure in which a plurality of aggregates and a plurality of carbon nanotube strands are intertwined. Due to the highly conductive properties of the carbon nanotubes in this composite, charge carriers can be rapidly transferred between the self-assembled aggregates. This composite may be prepared by preparing a dispersion in which the nanoparticles and/or carbon nanotubes are dispersed without any organic binders, simultaneously spraying the nanoparticles and the carbon nanotubes on a current collector through electrospray, and then subjecting the composite material formed on the current collector to a heat treatment.

### CROSS-REFERENCE TO RELATED APPLICATIONS

This application claims the benefit of Korean Patent Application No. 10-2010-0105389, filed on Oct. 27, 2010, in the Korean Intellectual Property Office, the disclosure of which is incorporated herein in its entirety by reference.

### BACKGROUND

1. Field

The present disclosure relates to electrode active materials for a secondary battery, and more particularly, to electrode active materials composed of mixed composites of a self-assembled electrode active material aggregate and carbon nanotube, a fabrication method thereof, and a secondary battery including the same.

2. Description of the Related Art

Currently, lithium ion secondary batteries are widely used not only as an electric power supply for small mobile electronic devices, but also as a high-output power source for stably driving electric tools, industrial robots, and electric vehicles due to its excellent energy conversion efficiency characteristics. The current research into and development of the lithium secondary batteries has been conducted largely in two directions. One approach is to increase the energy density of the battery to enable a longer use time in a smaller volume, while the other is to realize a lithium ion battery with a high output density based on rapid charging and discharging. Building up on such progress in research, the field of application for the lithium ion secondary batteries shows a tendency to expand from pre-existing small mobile electric power sources to a medium-to-large scale electric power supply source market.

A secondary battery is largely composed of a positive electrode active material, a negative electrode active material, a separator, and a current collector. Materials such as LiCoO₂ with a layered structure, spinel LiMn₂O₄, and LiFePO₄ with an olivine crystal structure are usually used as the positive electrode active material, and various carbon-based materials are used as the negative electrode active material. Of the carbon-based materials, graphite, a representative negative electrode active material, has advantages such as low discharge voltage, typical capacity (372 mAh/g), and a service life of a certain level or more. However, a lithium secondary battery with graphite adopted as the negative electrode material has the disadvantage of degradation in performance upon rapid charging and discharging, and thus, it is not suitable for electric vehicles and electric power storage. In addition, graphite has limitations in use for a long period of time due to its limitation in capacity. In order to overcome these limitations, active research has been conducted on silicon, which has a theoretical capacity larger than those of carbon-based materials (372 mAh/g), tin-based electrode active materials with high capacity, or Li₄Ti₅O₁₂ materials, which are excellent in output and cycle properties.

Recently, research has been active in applying nanostructures (nanomaterials) or porous structures on secondary batteries. The use of electrode active materials with a nanostructure or porous structure affords a solution for the volume expansion problem of conventional high capacity electrode active materials (Si, Sn, etc.) and imparts high output properties to lithium secondary batteries through the rapid diffusion of lithium. Since the diffusion time is proportional to the square of the particle size, the decrease in diffusion time of lithium may lead to a high-speed charge-discharge performance under high current, ultimately achieving a large increase in the output density. However, in the case of materials with an individual nanostructure, handling is quite difficult and the connection characteristics to the current collector under them are degraded, in turn, leading to a severe degradation in mechanical and electrical properties. This is a serious problem directly related to the service life of a lithium secondary battery.

Therefore, the electrode active material structure needs to be an aggregate of uniformly agglomerated particles, instead of an individual nanostructure. In addition, there is a need to develop a technology for fabricating an electrode layer having high mechanical and electrical stability with the substrate under it.

In particular, there is a need to develop an electrode active material structure mixed with a conductive material so as to improve low electric conductivity properties of electrode active materials. Furthermore, it is important to develop an electrode thin layer configured without the addition of other organic binders so that it may maximize the output properties of a secondary battery.

### SUMMARY

Provided are composites of electrode active materials for a lithium secondary battery, which obviate the use of organic binders in their fabrication, are able to form a thick film on a current collector with ease, and have improved properties in terms of mechanical strength and transfer of electrons and lithium ions.

Provided are a fabrication method of composites of electrode active materials for producing a thin layer of electrode active material on a current collector in a rapid yield and in a large area.

Additional aspects will be set forth in part in the description which follows and, in part, will be apparent from the description, or may be learned by practice of the presented embodiments.

According to an aspect of the present invention, a composite of electrode active material includes an aggregate of self-assembled electrode active nanoparticles and carbon nanotubes. The composite of electrode active material of the present invention is in the form of a network of aggregate-nanotube, in which the electrode active material nanoparticles which have formed the aggregates through self-assembly are linked by the carbon nanotubes. More specifically, it is in the form of an entanglement in which a plurality of aggregates and carbon nanotube strands are intertwined with each other.

According to another aspect of the present invention, a method of fabricating the composite of electrode active material includes:

(a) preparing a dispersion of electrode active material nanoparticles and a dispersion of carbon nanotubes;

(b) electrospraying the dispersions on a current collector, either separately or in combination, to form a composite of electrode active material as a network of a self-assembled aggregate of electrode active material and the carbon nanotubes; and

(c) subjecting the composite of electrode active material formed on the current collector to a heat treatment.

The method may further include (b′) pressing the composite of electrode active material between the above-described steps (b) and (c).

According to an aspect of the present invention, in preparing dispersions in (a), electrode active material nanoparticles may be dispersed in a solvent and the dispersed nanoparticles may be ground by microbead milling to obtain very homogeneous colloidal dispersions. According to a specific embodiment, the microbead milling may be performed by using microbeads with a diameter of about 0.1 mm or less. According to a more specific embodiment of the fabrication method of the present invention, the microbeads are zirconia microbeads.

According to another specific embodiment of the present invention, the electrospraying in step (b) may be performed in a manner of spraying simultaneously from a plurality of spray nozzles composed of at least one spray nozzle containing the dispersion of electrode active material nanoparticles and at least one spray nozzle containing the dispersion of carbon nanotubes.

According to another specific embodiment of the present invention, the electrospraying in step (b) may be performed in a manner of spraying a single dispersion in which the dispersion of electrode active material nanoparticles and the dispersion of carbon nanotubes are mixed.

### BRIEF DESCRIPTION OF THE DRAWINGS

These and/or other aspects will become apparent and more readily appreciated from the following description of the embodiments, taken in conjunction with the accompanying drawings of which:

FIG. 1 is a conceptual view illustrating an embodiment of the present invention in which self-assembled aggregates of electrode active material nanoparticles form a composite with carbon nanotubes.

FIG. 2 is a schematic view of a fabrication process of a composite of electrode active material describing a simultaneous electrospraying of a dispersion of carbon nanotubes and a dispersion of electrode active material using two different nozzles in an embodiment of the present invention.

FIG. 3 is a schematic view of an embodiment of the present fabrication process describing electrospraying a mixed dispersion in which carbon nanotubes and electrode active material nanoparticles are included together.

FIG. 4 is a scanning electron microscope (SEM) photograph (×10,000) of self-assembled TiO₂ aggregate-double walled carbon nanotube composite obtained by electrospraying in Example 1.

FIG. 5 is a higher magnification SEM photograph (×50,000) of FIG. 4.

FIG. 6 is an SEM photograph of a self-assembled TiO₂ aggregate-double walled carbon nanotube composite obtained by electrospraying in Example 2.

FIG. 7 is an SEM photograph of a self-assembled TiO₂ aggregate-double walled carbon nanotube composite obtained by electrospraying in Example 3.

FIG. 8 is an SEM photograph of a self-assembled Li_{0.99}Nb_{0.01}FePO₄ aggregate-double walled carbon nanotube composite obtained by electrospraying in Example 4.

FIG. 9 is an SEM photograph of a self-assembled and carbon-coated LiFePO₄ aggregate-double walled carbon nanotube composite obtained by electrospraing in Example 5.

FIG. 10 is an SEM photograph of self-assembled TiO₂ aggregates from Comparative Example 1.

FIG. 11 is an SEM photograph of a cross section of self-assembled TiO₂ aggregates from Comparative Example 1.

FIG. 12 is an SEM photograph of self-assembled TiO₂ aggregates from Comparative Example 2.

FIG. 13 is an SEM photograph of self-assembled Li_{0.99}Nb_{0.01}FePO₄ aggregates from Comparative Example 3.

FIG. 14 is an SEM photograph of self-assembled and carbon-coated LiFePO₄ aggregates from Comparative Example 4.

FIG. 15 is a graph showing the changes in discharging capacity with respect to the number of cycles of each secondary battery under varying charging-discharging rates (C-rates) for the negative active material either comprising the TiO₂ aggregate-carbon nanotube composite in Example 1 or the nanoparticle aggregate in Comparative Example 1, respectively.

FIG. 16 is a graph showing discharge capacity values at 0.2 C-rate against the cycle of a secondary battery in which an electrode active material composed of only nanoparticle aggregates in Comparative Example 1 is used as the negative electrode.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

According to an aspect of the present invention, an electrode active material composite forming a network in which carbon nanotubes connect electroactive material aggregates produced by self-assembly of electrode active nanoparticles is disclosed. According to an embodiment of the present invention, the electrode active material composite is a network of electrode active material nanoparticle aggregates and carbon nanotubes. More particularly, it is an entangled network in which carbon nanotube strands are intertwined with each other while at the same time the entangled strands encompass the nanoparticle aggregates.

As used herein, the term “electrode active material nanoparticle” refers to a particle of a positive or negative electrode active material having a nanometer-scale diameter. In embodiments of the present invention, an appropriate diameter for a nanoparticle of an electrode active material is in the range of about 2 nm to about 100 nm on average. However, the numerical range is not critical because individual electrode active material nanoparticles gather to form aggregates in the inventive electrode active material composite. That is, even in the case where the particles of the electrode active material somewhat deviate from the upper and lower limits of the diameter range, the object of the present invention may be achieved without undue difficulty provided that the difference is not so large and these particles form nanoparticle aggregates in such size ranges and forms as described in embodiments of the present invention. Therefore, although the term “nanotube” is used in embodiments of the present invention, it will be obvious that particles of the electrode active material with sizes somewhat deviating from the numerical range described above are also included in the scope of the present invention.

As used herein, the term “self-assembly” refers to a process in which nanoparticles spontaneously gather to form a lump in order to minimize the surface energy in the total system. Self-assembly leads to the formation of a relatively loosely bound aggregate without any covalent bonds. That is, the self-assembly is a spontaneous process occurring without any energy input when environmental conditions such as composition, pH, and concentration of a solvent are appropriate. In aggregates formed through self-assembly, nanoparticles in the interior thereof may be relatively strongly bound to each other, but most often the aggregate separates back into individual nanoparticles when environmental conditions under which the aggregate has been formed are changed.

An electrode active material composite of the present invention includes composites of self-assembled electrode active material nanoparticles and carbon nanotubes, and the composites and nanotubes form a network. The nanoparticles are an active material particle of at least one selected from positive and negative electrode active materials. The electrode active material may be used as an electrode active material for various fields of devices for energy storage and electricity generation, such as lithium secondary batteries, fuel cells or electrochemical capacitors, and the like.

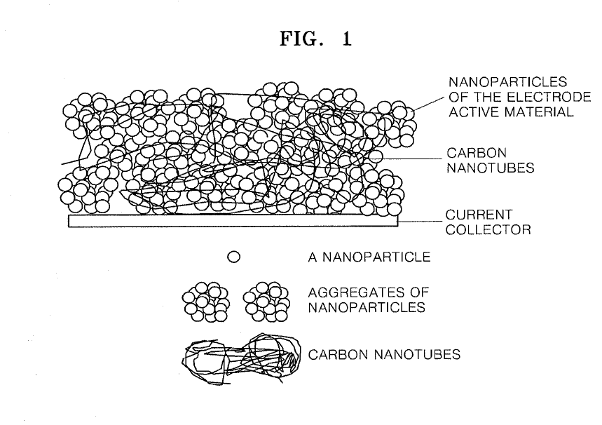

Referring to FIG. 1, an embodiment of an electrode active material composite of the present invention is described. FIG. 1 is a schematic view illustrating a configuration in which the nanoparticles of an electrode active material in an embodiment of the present invention form an aggregate having the shape of a grape cluster. The nanoparticles within this aggregate are connected to each other by carbon nanotubes to form a network structure. Although the overall shapes of the aggregates in the embodiment of FIG. 1 are spherical, this is only an embodiment of the present invention and the nanoparticle aggregates of the present invention are not limited to any specific shape.

From FIG. 1, it can be seen that a plurality of strands of carbon nanotubes, whose lengths are much longer than and diameters thinner than those of the aggregates form a complicated entanglement with each other among the aggregates. In the embodiment of FIG. 1, the electrode active material composite is formed on a current collector. Although not obvious in FIG. 1, carbon nanotubes in the electrode active material composite of the present invention may penetrate into the interior of a nanoparticle aggregate or pass through the aggregate to be entangled with another carbon nanotube strand and/or another aggregate on the opposite side.

In an embodiment, carbon nanotubes and electrode active material nanoparticle aggregates, as illustrated in FIG. 1, form a network in the electrode active material composite. Such network is characterized by an entanglement in which the carbon nanotube strands are intertwined with each other among electrode active material nanoparticle aggregates. That is, at least some carbon nanotube strands physically connect two or more of aggregates which are not directly contacting each other. In addition, a plurality of these carbon nanotube strands is entangled with each other between a plurality of aggregates. The entanglement prevents aggregates from being dissociated into nanoparticles or aggregates formed from coalescing together to form large lumps.

For the electrode active material composite of the present invention, materials that are used as devices for energy storage, for example, a positive or negative electrode active material for a lithium secondary battery, can be used as active material nanoparticles, and they are not specially limited as long as they may form nanoparticles and aggregates thereof.

For example, negative electrode active materials such as Si, Sn, Li₄Ti₅O₁₂, SnSiO₃, SnO₂, TiO₂, Fe₂O₃, Fe₃O₄, CoO, Co₃O₄, CaO, MgO, CuO, ZnO, In₂O₃, NiO, MoO₃, WO₃, or a mixed phase thereof can be used for the inventive nanoparticles of negative electrode active material. In addition, alloys with crystalline to amorphous structures, in which Si—Sn—Ti—Cu—Al—Ce or Si—Sn—Ti—Cu—Al—La are mixed, are also included as available negative electrode active material nanoparticles.

For the inventive nanoparticles of positive electrode material, materials such as LiMn₂O₄, V₂O₅, LiCoO₂, LiNiO₂, LiFePO₄, CuV₂O₆, NaMnO₂, NaFeO₂, LiNi_{1-y}CO_{y}O₂, and Li[Ni_{1/2}Mn_{1/2}]O₂, as well as, doped materials such as LiFePO₄, Li[Ni_{1/3}Co_{1/3}Mn_{1/3}]O₂, Li[N_{1/2}Mn_{1/2}]O₂, LiNi₁₋ₓCoₓO₂, where an ion selected from the group consisting of Mg²⁺, Al³⁺, Ti⁴⁺, Zr⁴⁺, Nb⁶⁺, and W⁶⁺ replaces the lithium site at a concentration of 1 at % or less can be used. In another embodiment, electrode active materials with a surface coating can be used as the nanoparticles for the electrode active material. For example, an electrode material having a surface covered with highly conductive carbon may be used.

According to an embodiment of the present invention, an aggregate of self-assembled nanoparticles may have any one shape selected from a sphere, a doughnut, or an ellipse. However, the nanoparticle aggregates need not be limited to any one of these three shapes in order to achieve the object of the present invention. Therefore, no particular limitation is imposed on the shape of the self-assembled nanoparticle aggregates. In a specific embodiment of the present invention, an electrode active material composite including the majority of aggregates that are substantially spherical in shape is used in order to achieve a high packing density of the electrode.

In an embodiment of the present invention, the diameter or size of the self-assembled aggregate may be in the range of about 100 nm to about 3 μm. When the size of the aggregate is in the range of about 100 nm to about 3 μm, micropores with various size ranges may be present among the aggregates, and the infiltration and movement of a liquid electrolyte may occur rapidly to improve the output properties of a lithium secondary battery. In addition, for lithium polymer electrolytes, a facile infiltration of ionic polymer electrolytes into micropores is advantageous because a rapid lithium ion transfer can be achieved. In a specific embodiment, the size of a self-assembled elliptical aggregate may be in the range of about 100 nm to about 3000 nm based on the major axis thereof, and the ratio of the major to minor axis is in the range of more than 1 and 5 or less. In another specific embodiment, it is preferable for a doughnut-type aggregate to have an outer diameter of about 500 nm to about 3000 nm and an inner diameter of about 100 nm to about 2000 nm.

Since pores with various sizes in the range of about 1 nm to about 500 nm are formed among self-assembled aggregates in the electrode active material composite of the present invention, lithium ions and electrolytes may move rapidly.

In the electrode active material composite of the present invention, carbon nanotubes are located in spaces between nanoparticle aggregates, and thus, electrically connect the aggregates. In addition, the carbon nanotubes attach to the surfaces of the nanoparticle aggregates, serve to substantially increase surface areas thereof, and enhance the electrical conductivity of a battery, improving its charge/discharge properties, and lengthening its service life. In addition, a carbon nanotube may penetrate into the interior of the aggregate or pass through an aggregate to be connected to another aggregate. Thanks to such properties of carbon nanotubes, the adhesion between the conductive current collector and the electrode material is enhanced. It is often the case that typical carbon nanotubes have some surface defects deviating from a perfect graphene sheet, and thus, protruding functional groups such as carboxylic groups are present on the surface of the defect as a result of the fabrication process. Without being bound to any particular theory, it is believed that the presence of such surface functional groups enhance adhesion on the surface of a conductive current collector.

The electron conductive properties are excellent in the electrode active material composite of the present invention, since carbon nanotubes with excellent conductive properties serve as a bridge connecting the aggregates while encompassing the self-assembled nanoparticle aggregates. An aggregate composed of nanoparticles alone without any reinforcing material such as carbon nanotubes, is formed by weak attraction between the nanoparticles, and in turn, the network of the active material is bound together only by the weak attraction between these aggregates. However, in the electrode active material composite of the present invention, carbon nanotubes hold the nanoparticle aggregates together, contributing to formation of a thin film of the active material with high mechanical stability. Furthermore, formation of an entangled network of carbon nanotubes and the aggregates can prevent further clumping of the aggregates or changes in particle size of the electrode active material that may occur upon the dissociation of the aggregates into individual nanoparticles, leading to a further increase in mechanical strength and packing density of the electrode.

All of the single-walled, double-walled, and multi-walled carbon nanotubes may be used as the carbon nanotube component in the inventive electrode active material composite, and if desired, carbon nanotubes having surfaces modified with a functional group may be used as well. A typical size is appropriate as a thickness of carbon nanotubes used in the composition of the present invention, and for example, nanotubes with a thickness of about 2 nm to about 40 nm may be used. The length of a carbon nanotube may range from a few micrometers to several tens of micrometers. In an embodiment of the present invention, carbon nanotubes with an average length of about 1 μm to about 20 μm are used. Advantageously, nanotubes with their lengths in this range can connect self-assembled nanoparticle aggregates to each other to form a network, thereby contributing to electrical conductive properties between aggregates.

In a specific embodiment of the present invention, most carbon nanotubes forming the network encompass the surfaces of the aggregates. In another specific embodiment of the present invention, carbon nanotubes forms a network by linking not only the surfaces of the aggregates but their interiors as well by penetrating into these nanoparticle aggregates. A structure in which carbon nanotubes connect deeply into the interior of an aggregate has an advantage in that electrical conductive properties may be greatly enhanced.

The composition of the inventive electrode active material composite preferably has carbon nanotubes present in an amount of about 0.01 to about 20 parts by weight based on 100 parts by weight of the total weight of the nanoparticles within the composite. For the purpose defining contents, the total weight of the nanoparticles is defined as a value including those nanoparticles that may be present within the composite without forming a nanoparticle aggregate in addition to the nanoparticles present as aggregates of the electrode active material described above. Advantageously, electrode active material composites containing carbon nanotubes in said range have high electric conductivities, low sintering temperatures, and excellent mechanical strengths.

The electrode active material composite of self-assembled nanoparticle aggregates and carbon nanotubes may further increase its packing density after being subjected to pressing and post-heat treatment and may decrease the contact resistance between nanoparticle aggregates or between the aggregates and the carbon nanotubes.

In another aspect of the present invention, the method of fabricating the electrode active material composite described above is disclosed. The method of fabricating an electrode active material of the present invention include:

(a) preparing a dispersion of electrode active material nanoparticles and a dispersion of carbon nanotubes;

(b) electrospraying the individual dispersions or the mixed dispersion thereof on a current collector to form a composite of electrode active material as a network of self-assembled aggregates of the electrode active material and the carbon nanotubes;

(c) optionally pressing the composite of electrode active material to increase the density; and

(d) subjecting the electrode active material to a heat treatment.

The method of fabricating an electrode active material composite is described in detail by steps as follows.

(a) Preparing a Dispersion

In a method of fabricating a composite of electrode active material, first, a dispersion in which the electrode active nanoparticles are uniformly dispersed and a dispersion in which carbon nanotubes are uniformly dispersed.

The nanoparticle dispersion includes negative electrode material or positive electrode active material nanoparticles in a solvent. These electrode active materials are not specifically limited. For example, the negative active electrode nanoparticle may include any one selected from Sn, Li₄Ti₅O₁₂, SnSiO₃, SnO₂, TiO₂, Fe₂O₃, Fe₃O₄, CoO, CO₃O₄, CaO, MgO, CuO, ZnO, In₂O₃, NiO, MoO₃, and WO₃, or a mixed phase of two or more nanoparticles thereof. The negative active electrode particle may also include alloys with a crystalline or amorphous structure, in which elements, such as Si—Sn—Ti—Cu—Al—Ce or Si—Sn—Ti—Cu—Al—La, and the like, are mixed. Materials, such as LiMn₂O₄, V₂O₅, LiCoO₂, LiNiO₂, LiFePO₄, CuV₂O₆, NaMnO₂, and NaFeO₂, LiNi_{1-y}Co_{y}O₂, Li[Ni_{1/2}Mn_{1/2}]O₂, as well as doped materials such as LiFePO₄, CuV₂O₆, NaMnO₂, NaFeO₂, LiNi_{1-y}Co_{y}O₂, and Li[Ni_{1/2}Mn_{1/2}]O₂, LiFePO₄, Li[Ni_{1/3}Co_{1/3}Mn_{1/3}]O₂, Li[Ni_{1/2}Mn_{1/2}]O₂, LiNi₁₋ₓCoₓO₂, and the like, where an ion selected from the group consisting of Mg²⁺, Al³⁺, Ti⁴⁺, Zr⁴⁺, Nb⁶⁺, and W⁶⁺ replaces the lithium site at a concentration of 1 at % or less can be used as a positive electrode active nanoparticle. In another embodiment, electrode active materials with a surface coating can be used as the nanoparticles for the electrode active material. For example, an electrode material having a surface covered with carbon may be used.

In general, when nanometer-scale electrode active material particles are to be dispersed in a liquid without adding a dispersing agent, aggregation of the particles usually takes place and the particles are present as aggregated powders with a size of a few to several hundred micrometers. Due to this aggregation, precipitation of the particles is observed during the dispersion of nanoparticles in the solvent. Such aggregated powders should not be present because these aggregates are directly responsible for nozzle clogging during electrospraying. However, aggregated powders, once formed in a solvent that includes nanoparticles in large quantities, are not easily broken by simple ultrasonication alone, and thus, it is difficult to disperse the powders.

In an embodiment of the present invention, the nanoparticles are ground with microbeads under wet conditions for stable electrospraying. In a specific embodiment, the average diameter of these microbeads is about 0.1 mm or less. In another specific embodiment, beads with a size of about 0.015 mm to about 0.1 mm may be used in order to obtain smaller nanoparticles. In a more specific embodiment of the present invention, aggregated powders are ground by microbead milling using zirconia balls under wet conditions. When microbead milling is used in this manner, a dispersion of uniform electrode active material nanoparticles can be prepared. As the conditions for microbead milling may be appropriately determined backwards from the properties of a desired composite of electrode active material by those skilled in the art, they will not be specifically described herein.

In the fabrication method of the present invention, the solvent for the dispersion may be selected from, but not limited thereto the group, consisting of ethanol, methanol, propanol, butanol, isopropanol (IPA), dimethylformamide (DMF), acetone, tetrahydrofuran, toluene, water, and any mixtures thereof.

In order to produce the aggregate after electrospraying, the volatilization rate of a solvent is also very important. In an embodiment of the present invention, a mixed solvent comprising a solvent with a boiling point (volatilization point) of about 80° C. or less in an amount of 50% or more, or a single solvent composed only of such solvent is used in order to produce the aggregate of nanoparticles easily during electrospraying.

In addition, the solvents may be divided into those in which water is mainly used in the dispersion and the others in which an organic solvent with a boiling point lower than that of water is mainly used in the dispersion. Solvents with boiling points lower than that of water include ethanol (CH₃CH₂OH, 78° C.), methanol (CH₃OH, 68° C.), tetrahydrofuran (THF, 66° C.), acetone (CH₃COCH₃, 56.2° C.), and the like, and electrospraying may be performed by using a dispersion in which a sufficient amount of the solvent is included for formation of a self-assembled aggregate.

Specifically, since the evaporation of solvent takes place simultaneously with the spraying of the nanoparticles from the injection nozzle when using ethanol, a strongly volatile solvent, the charged particles form nanoparticle aggregates in shapes selected from at least one of spheres, doughnuts, and ellipses to minimize their surface areas. On the contrary, when water, a solvent low in volatility, is used, not much evaporation of the solvent takes place until the nanoparticles are coated on a conductive current collector after being sprayed out of the injection nozzle. In summary, due to the simultaneous evaporation of water and coating of the nanoparticles on the current collector, obtaining aggregates with a uniform size distribution is difficult and the nanoparticles are applied on the current collector in the form of a thin layer with a high density rather than an regularly ordered aggregate. In this regard, forming the electrode layer in the form of a thin layer with a high density is preferable over aggregates in such cases as in coating a solid electrolyte over a thin layer of the electrode active material by vapor deposition. This is because in the above-mentioned type of electrodes, the presence of a dense layer of electrode active material beneath the solid electrolyte improves properties of the interface between the solid electrolyte and the electrode active material.

When preparing the dispersion of the electrode active material nanoparticles of the present invention, it is suitable to disperse the nanoparticles in a solvent, such that they are present in an amount of about 0.5% to about 20% by weight based on the total weight of the dispersion. Dispersing the electrode active material nanoparticles in the above concentration range facilitates electrospraying. Because there is a limitation in solubility at which nanoparticles may be uniformly dispersed, it is impossible to grow the size of the aggregate indefinitely, and it is preferable that the size of self-assembled aggregates is selected in the range of about 100 nm to about 1.5 μm.

A dispersion in which carbon nanotubes are uniformly dispersed in a solvent is also prepared. For the carbon nanotubes of the present invention, typical carbon nanotube ink, for example, may be used as, and there is no particular limitation as to the use of single-walled, double-walled or multi-walled carbon nanotubes. The carbon nanotube dispersion comprises at least one of dispersions selected from single-walled, double-walled, and multi-walled carbon nanotubes. The solvent as described above may be used as a solvent for the carbon nanotubes.

In the present method, the carbon nanotube dispersion suitably comprises carbon nanotubes in an amount of about 0.1% to about 5% by weight based on the total weight of the dispersion.

It is also possible to have a mixed dispersion in which the dispersion of electrode active material nanoparticles and the dispersion of carbon nanotubes are mixed together. When the mixed dispersion has a composition with about 90% to about 99.9% by weight of the electrode active material nanoparticles and about 0.01% to about 10% by weight of the carbon nanotubes based on a total weight of the dispersion, electrospraying in the subsequent step may be easily performed. The dispersion of electrode active material nanoparticles and the dispersion of carbon nanotubes may further include additives apart from a binder, in addition to the carbon nanotubes or electrode active material nanoparticles as described above. The additives include additives for electrospraying, dispersing agents, stabilizing agents, sintering additives, and the like, and a desired additive suitable for the final purpose and an appropriate input amount thereof may be determined by those skilled in the art based on the description provided herein.

For example, any additive for electrospraying widely used in the art is suitable for the present invention. For example, acetic acid, stearic acid, adipic acid, ethoxyacetic acid, benzoic acid, nitric acid, cetyltrimethyl ammonium bromide (CTAB), and the like, may be used. It is appropriate to include the additive in an amount of about 0.01% to about 10% by weight based on the total weight of the dispersion.

The composite of electrode active material according to the present invention is characterized in that it can be prepared without adding any organic binder, such as conventional rubber-based polymer materials, poly(vinylidene fluoride) (PVdF), to the dispersion. When an organic binder, an insulator, is included, a small amount of the residual binder may coat the surfaces of the electrode active material particles to inhibit the insertion and dissociation of lithium ions. As a result, high efficiency discharging properties may significantly deteriorate. Furthermore, as the content of the binder increases, it becomes increasingly cumbersome as a higher sintering temperature or a longer sintering time is required to fully remove the residual binder. On the contrary, when the amount of the binder added is reduced to maintain the discharging properties, preparing electrodes in the form of a sheet becomes difficult as the material for the electrode plate peels off from the metal core, and defects increase during fabrication of the electrode plate. The inventive composite of electrode active material obviates the need for organic binders in the dispersion since the carbon nanotubes prevent the additional coagulation of the aggregates or their dissociation into nanoparticles and enhances adhesion on the conductive current collector. Therefore, the process is not only simplified, but also prevents the likelihood of the above-mentioned problems from the beginning.

(b) Preparing the Composite of Electrode Active Material by Electrospraying

In operation (b) of the inventive fabrication method, each of the dispersions or the mixed dispersion obtained in the step for preparing dispersions is electrosprayed to prepare a composite of electrode active material.

Electrospraying is a method of forming charged small droplets by passing a liquid through a narrow passage way, such as a capillary tube, under applied voltage, followed by either dispersing the droplets on a desired surface, or obtaining an aerosol of the droplets. In a specific embodiment of the fabrication method of the present invention, the dispersion is further ground and/or stirred for dispersion, prior to the electrospraying step. For example, stirring is performed by using an ultrasonicator for 1 to 60 min, and then electrospraying is performed.

A device for electrospraying comprises an injection nozzle connected to a metering pump with which a dispersion may be quantitatively introduced, a high voltage generator, a grounded conductive substrate. First, the current collector is placed on the grounded conductive substrate. Then, the grounded conductive substrate is used as the negative plate, while an injection nozzle to which a pump for regulating the discharge volume per hour is attached is used as the positive electrode.

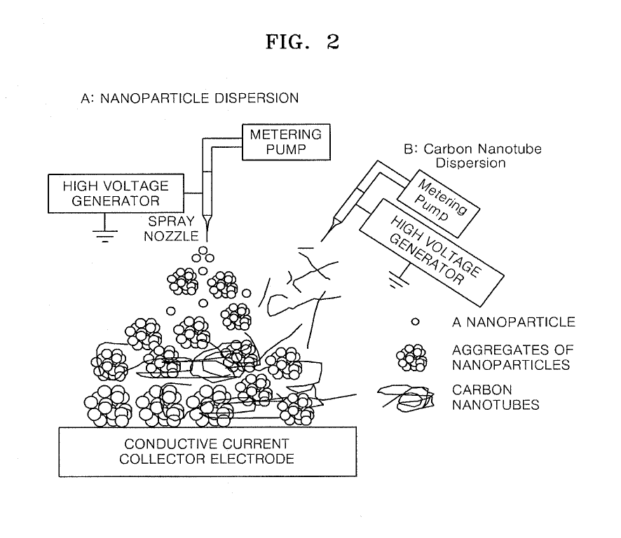

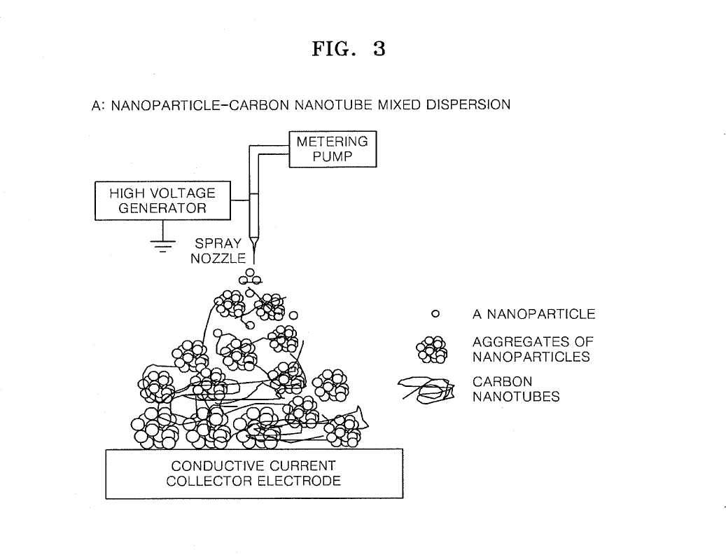

When a dispersion of electrode active material nanoparticles and a dispersion of carbon nanotubes are each prepared, both of the dispersions is transferred to an electric injection device which employs at least one injection nozzle per dispersion as shown in, for example, FIG. 2, and both dispersions are simultaneously sprayed. In addition, as shown in FIG. 3, a mixed dispersion including both electrode active material nanoparticles and carbon nanotubes may be electrosprayed through one injection nozzle.

As in FIG. 2, when separate dispersions and injection nozzles are used for electrode active material nanoparticles and carbon nanotubes, it is appropriate to set the spray amount and rate, such that both dispersions are simultaneously injected at a mixing ratio of the nanoparticle dispersion to the nanotube dispersion at about 1:0.05 to about 1:1 based on the concentrations described above for step (a).

The weight ratio of the aggregates of electrode active material nanoparticles and the carbon nanotubes may be controlled by varying the voltage applied for electrospraying, size of the needle, flow rate, and the distance between the tip of the needle and the substrate. Electrospraying can be performed to obtain the above-mentioned composition for the composite of electrode active material by controlling these injection conditions. In a specific embodiment of the present invention, it is preferable to have a weight ratio of the electrode active material nanotubes to carbon nanotubes in the range of about 90:10 to about 99.9:0.1.

In an embodiment of the present invention, the conditions for electrospray of electrode active material nanoparticles are controlled such that the size of nanoparticle aggregates on the conductive current collector is in the range of about 100 nm to 3 μm. Optimal control of the voltage and dispensing rate for electrospray, the type of injection nozzle, and the composition of the dispersion to keep the size of aggregates within this range can be readily obtained through routine experiments by those skilled in the art, and thus, the description thereof will not be provided herein. For example, in a typical case, a voltage of about 8 to about 30 kV may be applied and the dispensing rate of a dispersion by an injection nozzle may be controlled within the range of about 10 μL/min to about 300 μL/min to spray the dispersion on a current collector until the thickness of the composite layer of an electrode active material is in the range of about 500 nm to about 50 μm.

The voltage and flow rate for electrospray of carbon nanotubes may be controlled in the range of about 8 kV to about 30 kV and 1 μL/min to 10 μL/min, respectively, to disperse the nanotubes on the current collector until the thickness of the composite layer of the electrode active material is in the range of about 500 nm to about 50 μm.

Since the inventive fabrication method is performed by electrospraying dispersions lacking any organic binders on a current collector, rather than by spraying a paste including organic binders, increasing the thickness of an electrode active material layer can also be readily achieved. That is, the electrode layer may be prepared on a current collector as a thick layer with a thickness of about 50 μm or more in order to increase the capacity of a unit cell, only by increasing the time for injection. A uniform thin layer may also be prepared by moving a lower current collector from side-to-side or rotating the collector. Furthermore, a continuous fabrication of thin layer capable of depositing over a wide area can also be afforded by increasing the number of injection nozzles to a few tens to a few thousands and arranging the nanoparticle dispersions and the carbon nanotube dispersions in an alternating fashion but not side-by-side with each other. That is, the technique may be applied to realize a large area roll-to-roll continuous coating.

In a specific embodiment of the present invention, a spherical shape for particles is preferably employed for the self-assembled aggregate on the conductive current collector in that a rapid diffusion of lithium ions can be expected from the high electrode packing density and directionless nature of the shape. When a dispersion of nanoparticles is sprayed for coating under electric field, nanoparticles discharged from an injection nozzle gather together in order to minimize the surface energy. Because nanoparticles with the spherical shape have the lowest surface energy, a spherical aggregate with an average diameter in the range of about 100 nm to about 3 μm would be formed if the optimization of conditions, such as the orifice size of an injection nozzle, the dispensing rate, the concentration of nanoparticles in the dispersion, and the injection distance, is achieved. The average particle diameter of spherical aggregates is in the range of about 100 nm to about 3 μm. Control of the particle diameter of the aggregate particles can be obtained by varying the content of nanoparticles in a dispersion during an electrospray process. For example, when a dispersion with 1% by weight of electrode active material nanoparticles is used, a small particle size for the self-assembled aggregates is obtained, ranging from about 600 nm or less. When a dispersion with 5% by weight of the nanoparticles is used, self-assembled aggregates with a particle size of about 1 μm may also be included in the distribution.

Although some preferred particle diameters of nanoparticle aggregates for electrospraying have been exemplified, the self-assembly of nanoparticles is greatly influenced by such variables as the solvent used, size of the nanoparticles, and charge density within the dispersion. Accordingly, the particle diameter of nanoparticle aggregates and electrospray conditions for obtaining the diameter are those parameters which may be easily controlled through routine experiments by those skilled in the art. Restrictions in specific sizes of aggregates obtained through an electrospray process are only advisory and illustrative, and are not intended to have any absolute sense.

When electrospraying is performed, the orifice size of an injection nozzle from which the dispersion is dispensed and the dispensing rate are also important for fine-tuning of the shape of an aggregate. When the discharge rate is too fast, spherical aggregates are not easily formed. Most of the aggregates are distributed in spherical shapes. Doughnut and elliptical shapes may be formed depending on electrospray conditions. Herein, it is not specifically limited to the shapes of self-assembled secondary aggregates.

As described above, the shapes of the aggregates may be controlled depending on how much water and an organic solvent with a boiling point lower than that of water are relatively present in the dispersion.

(c) Pressing a Composite of Electrode Active Material

The fabrication method of the present invention may further include pressing a composite of electrode active material selectively in order to further increase the density of the composite in which self-assembled nanoparticle aggregates after electrospraying and carbon nanotubes are entangled with each other and improve the adhesion strength with a substrate. Depending on the pressing strength, some of the spherical, doughnut, or elliptical aggregates may be flatly skewed. The pressing may be performed, for example, by using a general uniaxial pressing or roll press. As methods conventionally known in the art may be used, the description is not provided herein.

(d) Subjecting a Composite of Electrode Active Material to a Heat Treatment

In the heat treatment operation of the inventive fabrication method, the composite of electrode active material formed by the preceding operations is subjected to a heat treatment. This heat treatment allows increases in both the binding force between nanoparticles which form the self-assembled aggregate as well as the binding force between self-assembled aggregates and carbon nanotubes, thereby increasing the mechanical stability of the composite.

The heat treatment is performed in the range of about 300° C. to about 500° C. When the temperature of the heat treatment exceeds about 500° C., some of the carbon nanotubes may be removed to lower the network properties between carbon nanotubes, thereby lowering electrical conductive properties thereof. Accordingly, it is preferable that the heat treatment is not performed at too high a temperature. When the heat treatment is performed at a temperature of about 300° C. or less, binding forces between particles and between carbon nanotubes and aggregates may be somewhat lowered.

In a specific embodiment of the present invention, the heat treatment may be performed at a temperature of about 300° C. to about 500° C. for 10 min to 2 hours.

According to another aspect of the present invention, a lithium secondary battery, including the composite of the electrode active material as described above, has been disclosed.

A lithium secondary battery of the present invention includes a current collector and an electrode formed on the current collector by using a composite of electrode active material of the present invention. Elements of a lithium secondary battery except for a composite of electrode active material, that is, the other elements of a secondary battery, including a current collector, are not specifically limited as long as they are typically used in the art.

Materials for the current collector may be any one selected from the group consisting of platinum (Pt), gold (Au), palladium (Pd), iridium (Ir), silver (Ag), ruthenium (Ru), nickel (Ni), stainless steel (STS), aluminum (Al), molybdenum (Mo), chromium (Cr), copper (Cu), titanium (Ti), tungsten (W), indium doped tin oxide (ITO), and fluorine doped tin oxide (FTO). In general, a secondary battery is composed of an electrode (including a current collector and a composite of electrode active material), an electrolyte, a separator, a case, a terminal, and the like. The secondary battery of the present invention is identical to a general secondary battery in configuration, except for the electrode. Examples of the electrolyte may include LiPF₆, and the electrolyte is not specifically limited as long as it may induce electrochemical reactions with a composite of electrode active material of self-assembled nanoparticle aggregates and carbon nanotubes.

A composite of electrode active material of the present invention and a fabrication method thereof may be applied to various energy storage devices, such as fuel cells, electrochemical capacitors, and the like, as well as lithium secondary batteries.

### EXAMPLE

Hereinafter, the present invention will be specifically described with reference to Examples. However, these examples are provided only for a clearer understanding of the present invention, and the present invention is not limited thereto.

### Example 1

### Preparation of a Composite of Electrode Active Material of Self-Assembled TiO₂ Aggregates-Double-Walled Carbon Nanotubes

In order to prepare a uniform dispersion of TiO₂ nanoparticles, 20 g of TiO₂ particles (Aldrich, US) with a size of about 25 nm were added to 180 g of ethanol to prepare a dispersion at 10% by weight. In order to achieve the uniform dispersion of TiO₂ particles, zirconia balls (Kyotobuki, Japan) with a size of about 0.1 mm were used to carry out a wet microbead milling. The wet microbead milling was performed at a speed of about 4000 rpm for 30 min. For the carbon nanotubes, about 1% by weight of double-walled carbon nanotubes available from Unidym Inc. (US) and dispersed in water was used.

In order to prepare a composite of electrode active material of TiO₂ aggregates-carbon nanotubes, each of the prepared dispersions was each transferred to a syringe, which was then mounted on an electrospray equipment, followed by electrospraying simultaneously with separate injection nozzles, as shown in FIG. 2.

A voltage of about 23 kV, the size of a needle of about 27 GA, a flow rate of about 30 μL/min, and a distance between the tip of the needle and the substrate of about 11 cm were employed for TiO₂ electrospraying. A voltage of about 23 kV, a size of a needle of about 30 GA, a flow rate of about 1 μL/min, and a distance between the tip of the needle and the substrate of about 11 cm were employed for carbon nanotube electrospraying, and the spraying was simultaneously started and performed for the same period. Under these conditions, the weight ratio of electrode active material nanoparticles applied on a current collector to carbon nanotubes is about 99:1.

The thickness of the electrode layer may be controlled depending on an injection time, and a thin layer with a thickness of about 5 μm was prepared in the present example.

A stainless steel substrate was used as a substrate for a current collector. A thin layer obtained after electrospraying may be subjected to pressing in order to increase the density thereof, and a post heat-treatment was performed under an atmosphere at about 400° C. for 30 min without being subjected to pressing in the present example. The heat treatment was performed in a box furnace.

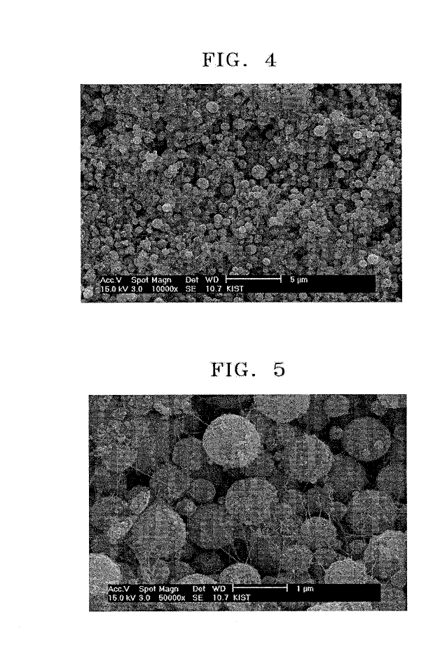

A scanning electron microscope (SEM) photograph (×10,000) of a thin layer of the composite of electrode active material of self-assembled TiO₂ aggregates-carbon nanotubes is shown in FIG. 4. Referring to FIG. 4, a porous structure can be confirmed in which large pores are well distributed between the self-assembled TiO₂ aggregates with a size of about 100 nm to about 800 nm. Referring to FIG. 5 which is an SEM photograph (×50,000) showing FIG. 4 in a higher magnification, it can be seen that the aggregates in which fine nanoparticles are clumped together are thoroughly entangled with carbon nanotube strands with thicknesses in the range of a few to a few tens of nanometers. That is, an entanglement is formed. Attainment of this entangled structure allows a large improvement in the electrical conductive properties as well as the mechanical strength since the aggregates and carbon nanotubes reinforce each other.

Although each of the dispersions of nanoparticles and carbon nanotubes was electrosprayed and coated by using two injection nozzles in the present Example 1, a continuous thin layer can also be prepared through deposition over a large area by increasing the number of injection nozzles by a few tens to a few thousands and arranging the nanoparticle dispersions and the carbon nanotube dispersions in an alternating fashion but not side-by-side with each other, as has been described above.

### Example 2

### Preparation of a Composite of Electrode Active Material of Self-Assembled TiO₂ Aggregates-Double-Walled Carbon Nanotubes

A thin electrode layer was prepared in the same manner as in Example 1, except that the content of carbon nanotubes in the entanglement of the composite of electrode active material was doubled by increasing the dispensing rate of carbon nanotubes to about 2 μL/min. The time for electrospraying was controlled to prepare a thin electrode layer having a thickness of about 5 μm. Under these conditions, the weight ratio of the electrode active material nanoparticles to carbon nanotubes applied on the current collector is about 98:2.

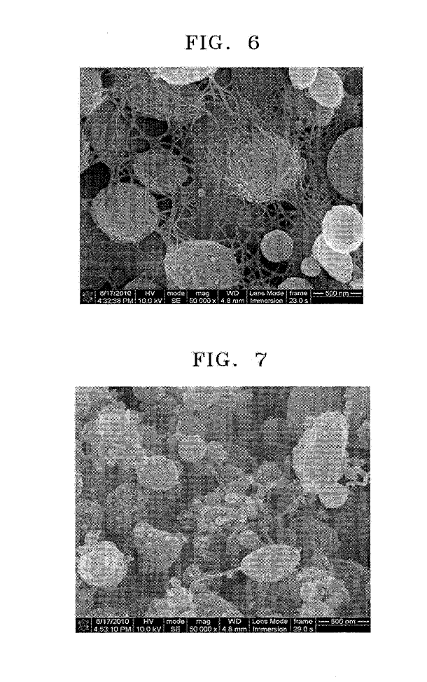

FIG. 6 is an SEM photograph (×50,000) of the composite of electrode active material. It can be seen that the content of carbon nanotubes was greatly increased compared to FIG. 5. Referring to FIGS. 5 and 6, it can be seen that carbon nanotubes are present while characteristically encompassing the surface of the aggregate.

Electrospraying was performed simultaneously from two injection nozzles in Examples 1 and 2. Ethanol was volatilized while the TiO₂ dispersion was dispensed from the injection nozzle, and aggregation took place into one or more shapes selected from spherical, elliptical, and doughnut shapes to reduce the surface energy. Because the aggregation proceeds as the nanoparticles are being accelerated toward the conductive current collector, the aggregates encounter carbon nanotubes to form a network before reaching the current collector. Therefore, carbon nanotubes mostly wind around the surface of the aggregate. When each of the carbon nanotubes and electrode active material nanoparticles is electrosprayed using separate injection nozzles, the shape of the aggregate can be maintained in substantially spherical, elliptical, and doughnut shapes, and the electrical conductive properties and mechanical stability properties among the aggregates are greatly enhanced.

### Example 3

### Preparation of a Composite of Electrode Active Material of Self-Assembled TiO₂ Aggregates-Multi-Walled Carbon Nanotubes

A TiO₂ dispersion was prepared in the same manner as in Example 1. Multi-walled carbon nanotubes were dispersed in ethanol to prepare a dispersion, followed by mixing the TiO₂ dispersion with the dispersion of carbon nanotubes to prepare a mixed single dispersion. As a result, it was found that TiO₂ and carbon nanotubes in the mixed dispersion are present in an amount of 98% and 2% by weight, respectively, based on the total weight of the dispersion.

After the prepared dispersion was mounted on an electrospray device, electrospraying was performed. A voltage of about 23 kV, a needle of a size about 30 GA, a flow rate of about 30 μL/min, and a distance between the tip of the needle and a substrate of about 11 cm were employed for TiO₂ electrospraying. A thin layer obtained after electrospraying may be subjected to pressing in order to increase the density thereof, and a post heat-treatment was performed under an atmosphere at about 400° C. for 30 min without being subjected to pressing in the present example. The heat treatment was performed in a box furnace.

An electrospraying time was controlled to prepare a thin layer with a thickness of about 5 μm.

An SEM photograph (×50,000) of a thin layer of a composite of electrode active material of self-assembled TiO₂ aggregates-multi-walled carbon nanotubes obtained after electrospraying is shown in FIG. 7.

Referring to FIG. 7, it was found that self-assembled TiO₂ aggregates with a size of about 200 nm to about 700 nm have readily formed a mixed structure in which the aggregates were connected to each other in a network via multi-walled carbon nanotubes. In particular, it was found that the self-assembled TiO₂ aggregates somewhat differed in shape from those obtained in Example 1, as shown in FIG. 5, and that these aggregates were closer to an elliptical shape than a spherical shape and the size distribution thereof was broader.

It was also found that not only a network was observable in which the multi-walled carbon nanotubes surrounded the surface of the TiO₂ aggregates, but also a complex, entangled structure in which the nanotubes have penetrated the interior as well, and come out of the aggregates to encompass the surface of other aggregates. Without being bound by any particular theory about the mechanistic principles of the present invention, it is believed, for the purpose of better understanding, such structures are attributable to the aggregation of the multi-walled carbon nanotubes taking place at the same time with the self-assembly of TiO₂ nanoparticles due to the use of a single injection nozzle during electrospraying. The above-mentioned structure has an advantage in that the structure may enhance the electrical conductive properties deep into the interior of the self-assembled aggregates. The shape may vary depending on the content and type of multi-walled carbon nanotubes used. Multi-walled carbon nanotubes, as well as single walled carbon nanotubes and double-walled carbon nanotubes, may be used as a mixed single dispersion prepared by mixing a dispersion of an electrode active material with a dispersion of carbon nanotubes

### Example 4

### Preparation of a Composite of Electrode Active Material of LiFePO₄ Aggregates-Double-Walled Carbon Nanotubes

In order to prepare LiFePO₄ powders added with 1 mol % Nb, by a solid-state reaction method, a precursor composed of Li₂CO₃, Nb(OCH₂CH₃)₅, FeC₂O₄.2H₂O, and NH₄H₂PO₄ mixed at a molar ratio of 0.495:0.01:1:1, was subjected to a ball milling in an acetone solvent for 24 hrs to obtain a mixed powder. After the mixed powder was dried, a heat treatment was performed under Ar atmosphere at about 350° C. for 10 hrs. Subsequently, a final heat treatment was performed at about 700° C. for 2 hrs to obtain a bulk powder of Li_{0.99}Nb_{0.01}FePO₄ in which nanoparticles were aggregated.

A wet microbead milling in a solvent medium was performed on the bulk powder of Li_{0.99}Nb_{0.01}FePO₄ obtained by the solid-state reaction method to prepare a dispersion in which fine nanoparticles were dispersed. Specifically, 2 g of the bulk powder of Li_{0.99}Nb_{0.01}FePO₄ obtained by the solid-state reaction method was mixed with 198 g of ethanol to obtain about 1% by weight of the powder, which was ground by using a wet microbead milling. The solvent used was ethanol. Zirconia balls with a size of about 0.1 mm were used as beads. In order to obtain smaller nanoparticles, beads with a size of about 0.015 mm to about 1.1 mm may be used. The wet microbead milling was performed at a rotation speed of about 4000 rpm for 30 min. After the wet microbead milling, the Li_{0.99}Nb_{0.01}FePO₄ dispersion was transferred to a glass bottle to prepare a Li_{0.99}Nb_{0.01}FePO₄ dispersion for electrospraying.

As for carbon nanotubes, about 1% by weight of double-walled carbon nanotubes available from Unidym Inc. (US) and dispersed in water was used.

As shown in FIG. 2, electrospraying was performed by using separate injection nozzles simultaneously. The electrospraying of the Li_{0.99}Nb_{0.01}FePO₄ dispersion was performed by applying a voltage of 23 kV, and an injection nozzle with a nozzle size of 27 GA was used. The gap between a current collector and a nozzle was about 15 cm, and the electrospraying was performed at a discharge rate of about 10 μL/min. A voltage of 23 kV, an injection nozzle size of 30 GA, and a flow rate of 1 μL/min were used in the electrospraying of nanotubes. The distance between a tip of a needle and a substrate was identical to those in previous Examples, and the electrospraying was simultaneously started and performed for the same period.

A stainless steel substrate was used as a current collector substrate. Time for electrospraying was controlled to prepare a thin layer with a thickness of about 5 μm as an electrode layer.

The thin layer obtained after electrospraying may be subjected to pressing in order to increase the density thereof, and a post-heat treatment was performed under Ar atmosphere at about 400° C. for 30 min without being subjected to pressing. The heat treatment was performed in a box furnace.

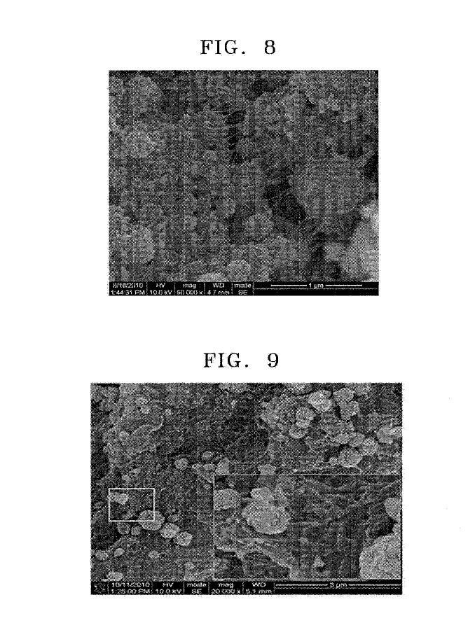

An SEM photograph (×50,000) of a thin layer of a composite of electrode active material of self-assembled Li_{0.99}Nb_{0.01}FePO₄ aggregates-carbon nanotubes obtained after electrospraying is shown in FIG. 8. Referring to FIG. 8, it was found that self-assembled Li_{0.99}Nb_{0.01}FePO₄ aggregates with a size of about 200 nm to about 800 nm had readily formed a mixed structure in which the aggregates were networked and connected to each other by double-walled carbon nanotubes. Li_{0.99}Nb_{0.01}FePO₄ is a positive electrode active material with an olivine crystal structure.

### Example 5

### Preparation of a Composite of Electrode Active Material of Carbon Coated LiFePO₄ Aggregates-Multi-Walled Carbon Nanotubes

A wet microbead milling was performed on a bulk powder of carbon-coated LiFePO₄ (Daejung Chemicals, Korea) to prepare a dispersion in which fine nanoparticles are dispersed. Specifically, 20 g of a bulk powder of carbon-coated LiFePO₄ obtained by the solid-state reaction method was mixed with 180 g of ethanol to obtain about 10% by weight of the powder, which was ground by using a wet microbead milling. Zirconia balls with a size of about 0.1 mm were used as beads. The wet microbead milling was performed at a rotation speed of about 4000 rpm for 30 min. After the wet microbead milling, the carbon-coated LiFePO₄ dispersion was transferred to a glass bottle to prepare a carbon-coated LiFePO₄ dispersion for electrospraying.

As for a multi-walled carbon nanotube (World Tube Co., Ltd, Korea) dispersion, a solution in which about 3% by weight of carbon nanotubes dispersed in alcohol was used.

As shown in FIG. 2, electrospraying was performed by using separate injection nozzles simultaneously. The electrospraying of the carbon-coated LiFePO₄ dispersion was performed by applying a voltage of 23 kV, and an injection nozzle with a nozzle size of 27 GA was used. The gap between a current collector and a nozzle was about 15 cm, and the electrospraying was performed at a discharge rate of about 10 μL/min. A voltage of 23 kV, an injection nozzle size of 30 GA, and a flow rate of 5 μL/min were used in the electrospraying of multi-walled nanotubes. The distance between a tip of a needle and a substrate was identical to those in previous Examples, and the electrospraying was simultaneously started and performed for the same period.

A stainless steel substrate was used as a current collector substrate. Time for electrospraying was controlled to prepare a thin layer with a thickness of about 5 μm as an electrode layer.

The thin layer obtained after electrospraying may be subjected to pressing in order to increase the density thereof, and a post-heat treatment was performed under Ar atmosphere at about 400° C. for 30 min without being subjected to pressing. The heat treatment was performed in a box furnace.

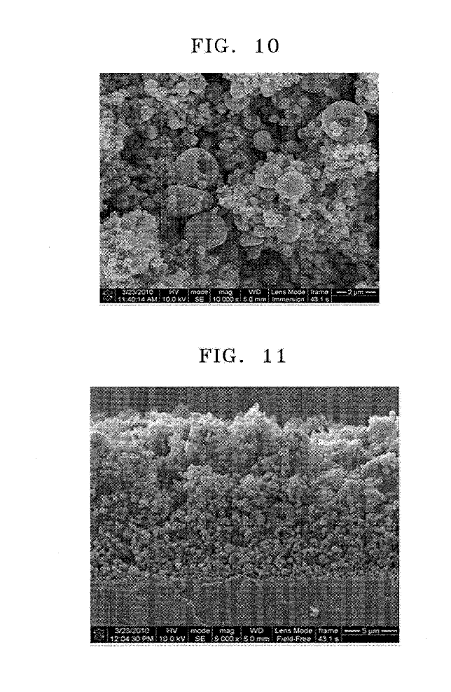

An SEM photograph (×50,000) of a thin layer of a composite of electrode active material of self-assembled LiFePO₄ aggregates-carbon nanotubes obtained after electrospraying is shown in FIG. 9. Referring to FIG. 9, it was found that self-assembled LiFePO₄ aggregates with a size of about 200 nm to about 600 nm had readily formed a mixed structure in which the aggregates were networked and connected to each other by multi-walled carbon nanotubes. Because the dispensed amount of multi-walled carbon nanotubes was larger than that of Example 4 in which the nanotubes were dispensed at a rate of about 5 μL/min, it can be seen that a large amount of multi-walled carbon nanotubes are entangled with carbon-coated LiFePO₄ aggregates in a network. This network distribution may be clearly observed from a right inset image, a magnification of the left square in FIG. 9.

### Comparative Example 1

### Preparation of Self-Assembled TiO₂ Aggregates

The TiO₂ dispersion prepared in Example 1 was electrosprayed alone to prepare a thin electrode layer on a current collector. All experimental conditions were identical to those in Example 1, except that a dispersion of carbon nanotubes was missing.

FIG. 10 is an SEM photograph (×10,000) of the thus-obtained thin electrode layer only composed of TiO₂ aggregates. The TiO₂ aggregates in which nanoparticles with spherical, elliptical, and doughnut shapes are self-assembled can be observed from the thin electrode layer in FIG. 10. It can be seen that TiO₂ aggregates with a distribution of variously sized aggregates from a spherical shape with a size of about 100 nm to a doughnut shape with a size of about 2 μm have formed.

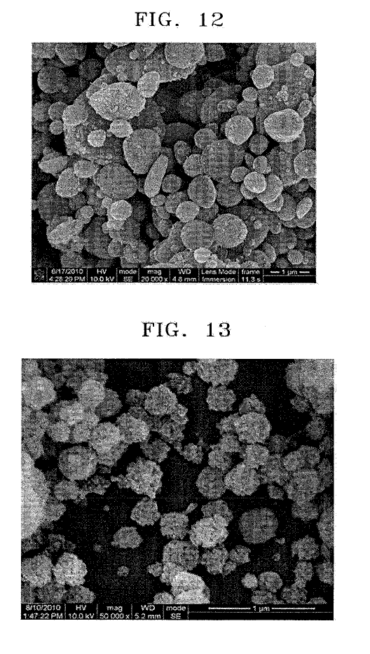

FIG. 11 is an SEM photograph (×5,000) of a cross-section of this thin electrode layer. From FIG. 11, it can be seen that the self-assembled aggregates formed a thin layer with a relatively high density. The presence of a large number of pores distributed between the self-assembled aggregates indicates that the thin layer has a structure into which an electrolyte may be easily infiltrated. Nanoparticle aggregates not held together by carbon nanotubes have very poor contact properties with the substrate. Because the binding strength thereof is so weak that the aggregates are easily separated from the metal substrate, it is difficult to fabricate a battery with high stability.

### Comparative Example 2

### Preparation of Self-Assembled TiO₂ Aggregates

The experiment was performed in the same manner as in Comparative Example 1, except that the size of an injection nozzle during electrospraying was changed from 27 GA to 25 GA.

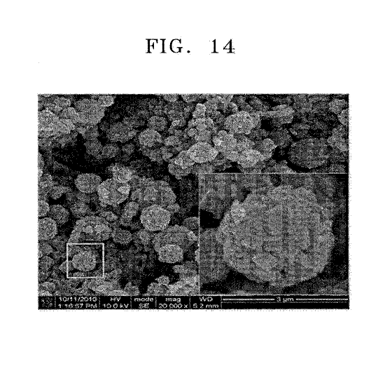

FIG. 12 is an SEM photograph (×10,000) of the thin layer thus-prepared. When compared to an aggregate in FIG. 10, a distribution with a doughnut shape was not observed. Rather, a TiO₂ aggregate structure that substantially has a skewed elliptical shape was observed. It was found that this aggregate was composed of fine TiO₂ anatase powder particles with a size of about 25 nm and a strong aggregation occurred during electrospraying.

### Comparative Example 3

### Preparation of Self-Assembled Li_{0.99}Nb_{0.01}FePO₄ Aggregates

The Li_{0.99}Nb_{0.01}FePO₄ dispersion obtained in Example 4 was used to perform a single electrospray. Process conditions for electrospraying were identical to those in Example 4.

FIG. 13 shows an SEM photograph (×50,000) of Li_{0.99}Nb_{0.01}FePO₄ aggregates with a size distribution of about 300 nm to about 500 nm. It was found that Li_{0.99}Nb_{0.01}FePO₄ nanoparticles with a size distribution of about 5 nm to about 50 nm coagulated to form aggregates that are substantially spherical in shape. In this case where the aggregates were not networked by carbon nanotubes, the electrical resistance properties of the Li_{0.99}Nb_{0.01}FePO₄ aggregates are expected to be very poor. Because the binding properties of at the interface between the conductive current collector and the ceramic thin layer are poor, the mechanical adhesion strength is greatly deteriorated, making it difficult to realize a secondary battery with long service life and stability.

### Comparative Example 4

### Preparation of Self-Assembled and Carbon-Coated LiFePO₄ Aggregates

The carbon-coated LiFePO₄ dispersion obtained in Example 5 was used to perform electrospray without the carbon nanotube dispersion. The process conditions for electrospraying were identical to those in Example 5.

FIG. 14 shows an SEM photograph (×20,000) of carbon-coated LiFePO₄ aggregates with a size distribution of about 300 nm to about 500 nm. It was found that carbon-coated LiFePO₄ nanoparticles with a size distribution of about 20 nm to about 100 nm were aggregated to form aggregates that are substantially spherical in shape. As observed from the right inset image, a magnification of the left square in FIG. 14, it is clearly observed that fine nanoparticles were aggregated to obtain the spherical shaped LiFePO₄ aggregates. However, the aggregates in this case were not networked by carbon nanotubes, and thus, the electrical resistance properties of the carbon-coated LiFePO₄ aggregates are expected to be very poor. Because the binding properties of at the interface between the conductive current collector and the ceramic thin layer are poor, the mechanical adhesion strength is greatly deteriorated, making it difficult to realize a secondary battery with long service life and stability

### Analysis Example 1

### Evaluation of Properties of a Lithium Secondary Battery which Uses a Composite of Electrode Active Material of Self-Assembled TiO₂ Aggregates-Double-Walled Carbon Nanotubes as a Negative Electrode

In order to evaluate performances of negative electrode thin layers applied on a stainless steel substrate, the composite of TiO₂-double-walled carbon nanotubes in Example 1 and the TiO₂ aggregates including no carbon nanotubes in Comparative Example 1 were respectively used for preparing coin cells (CR2032-type coin cell) as follows. In the cell configuration, an EC/DEC (1/1% by volume) solution in which 1 M LiPF₆ was dissolved was used as an electrolyte. A lithium metal foil (Foote Mineral Co., US) with a purity of 99.99% was used as the negative electrode for both the reference electrode and the counter electrode, while a thin layer including the composite of electrode active material prepared in Example 1 was used as the working electrode. A polypropylene film (Celgard Inc., USA) was used as a separator for preventing an electrical short between negative and positive electrodes, and an argon atmosphere was created in a glove box from VAC Corp., USA, followed by fabrication of this cell.

The charge/discharge experimental device herein used was a WBCS3000 model from WonATech Co., Ltd, and changes in voltage were observed under constant current by a multi potentiostat system (MPS), such that 16 boards were added to realize measurement by 16 channels. 5 cycles of the intensity of current density used during charging/discharging were measured based on 0.5 C-rate to 10 C-rate by calculating a theoretical capacity of each material. The cut off voltage was in a range of about 0.01 V to about 3.0 V.

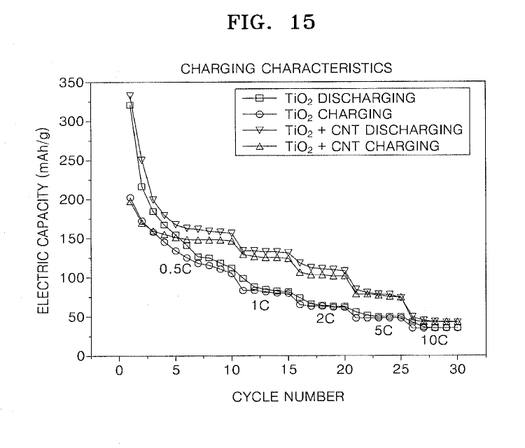

FIG. 15 is a graph showing the measured changes in discharging capacity with respect to the number of cycles at 0.5 C to 10 C using the thin layer of the TiO₂ aggregate-carbon nanotube composite in Example 1 and the TiO₂ aggregate in Comparative Example 1, respectively s the negative active material. In the box for describing the symbols, what is shown as TiO₂-carbon nanotube and TiO₂ are data of Example 1 and Comparative Example 1, respectively. In the case of a secondary battery comprising only the self-assembled TiO₂ aggregates of Comparative Example 1 in FIG. 15, it was found that the initial discharge capacity value is about 200 mAh/g at 0.5 C and the capacity drastically decreases as the number of cycles goes from 1 C to 10 C. The poor performance exhibited at rapid charging and discharging can be attributed to the poor electrical conductive properties of the TiO₂ aggregates. On the contrary, the secondary battery that uses the thin layer of the composite electrode active material of self-assembled TiO₂ aggregates-double-walled carbon nanotubes obtained in Example 1 clearly demonstrates in FIG. 15 that it had a high initial discharge capacity (330 mAh/g) and superior rapid charge/discharge properties. This is due to the fact that the TiO₂ aggregates are connected to each other by carbon nanotubes with excellent conductive properties.

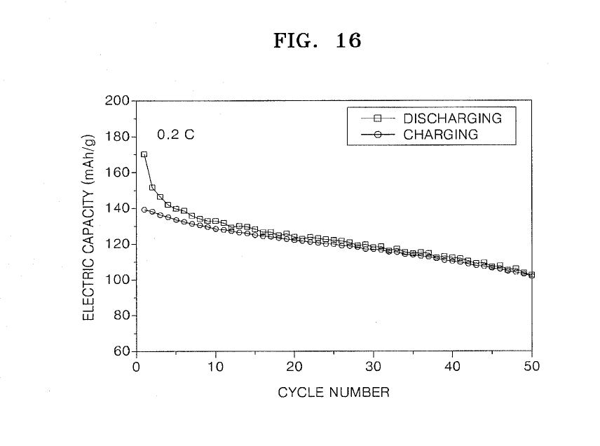

FIG. 16 is a graph showing the discharge capacity values against the cycle of for a secondary battery in which self-assembled TiO₂ aggregates in Comparative Example 1 are used as the negative electrode. Charge/discharge tests were performed at the rate of 0.2 C. It was found that the initial value was about 170 mAh/g and about a 40% decrease in capacity occurred at 50 cycles, compared to the initial value as the number of cycles increased. Because the thin layer of electrode active material was formed without using other conductive materials in Comparative Example 1, it is believed that poor electron transfer properties are responsible for the deterioration in cycle properties and decrease in capacity.

From the above data, it has been demonstrated that the use of the inventive composite of electrode active material having an entangled structure in which carbon nanotubes and electrode active material nanoparticle aggregates are intertwined provides service-life stability, excellent charge/discharge properties, and high mechanical strength for the lithium secondary battery. On the contrary, when carbon nanotubes were not used, the decrease in capacity was remarkable as the cycle proceeded.

The electrode active material composite of the present invention enhances the mechanical stability of the electrode active material layer and its adhesion on the conductive current collector and increases the service life of lithium secondary batteries. The rapid electron transfer properties of carbon nanotubes facilitate ready transfer of electrons between the aggregates, leading to a significant improvement in the high-output properties of the battery. Since the present invention obviates the use of organic binders, it can decrease the overall cell resistance, and the high output properties of the lithium secondary battery can be further improved. Because the thickness of the porous composite electrode active material layer can be easily controlled by controlling the spraying time in the present method, films can be readily prepared in widths ranging from thin film to thick film. In addition, with a plurality of nozzles, a continuous, roll-to-roll coating over a large area can be supported.

A composite of electrode active material of the present invention and a fabrication method thereof may be applied to various energy storage devices, such as fuel cells, electrochemical capacitors, and the like, besides lithium secondary batteries.

Although the present invention has been described with reference to illustrated examples, they are merely illustrative. It should be understood that various modifications and equivalent other embodiments thereof apparent to those skilled in the art may be made.

1. A composite of electrode active material, the composite comprising:
a plurality of nanoparticle aggregates in which the electrode active material nanoparticles are self-assembled; and
a network comprising a plurality of carbon nanotubes,
wherein the plurality of aggregates and the plurality of carbon nanotube strands are intertwined to form an entanglement.

2. The composite of claim 1, wherein the composite has a composition with the carbon nanotubes present in an amount of about 0.01 to about 20 parts by weight based on 100 parts by weight of the electrode active nanoparticles.

3. The composite of claim 1, wherein the self-assembled aggregates comprise spherically shaped aggregates, and the sizes of the spherical-shaped aggregates are in the range of about 100 nm to about 3 μm.

4. The composite of claim 1, wherein the self-assembled aggregates comprise elliptically shaped aggregates, and the major axis length of the elliptically shaped aggregate is in the range of about 100 nm to 3 μm, and the ratio of the major to minor axis is in the range of more than 1 to 5 or less.

5. The composite of claim 1, wherein the self-assembled aggregates comprise doughnut-shaped aggregates, and the doughnut-shaped aggregate has an outer diameter in the range of about 500 nm to about 3 μm and an internal diameter in the range of about 100 nm to about 2 μm.

6. The composite of claim 1, wherein the nanoparticle aggregates comprise pores with a size of about 1 nm to about 500 nm.

7. The composite of claim 1, wherein the electrode active material nanoparticle is a material selected from the group consisting of Si, Sn, Li₄Ti₅O₁₂, SnSiO₃, SnO₂, TiO₂, Fe₂O₃, Fe₃O₄, COO, CO₃O₄, CaO, MgO, CuO, ZnO, In₂O₃, NiO, MoO₃, WO₃, and any mixtures thereof; and the group consisting of crystalline or amorphous alloys of Si—Sn—Ti—Cu—Al—Ce and Si—Sn—Ti—Cu—Al—La.

8. The composite of claim 1, wherein the electrode active material nanoparticle is at least one selected from the group consisting of LiMn₂O₄, V₂O₅, LiCoO₂, LiNiO₂, LiFePO₄, CuV₂O₆, NaMnO₂, NaFeO₂, LiNi_{1-y}CO_{y}O₂; and the group consisting of doped materials of Li[Ni_{1/2}Mn_{1/2]O}₂, LiFePO₄, Li[Ni_{1/3}Co_{1/3}Mn_{1/3}]O₂, Li[Ni_{1/2}Mn_{1/2}]O₂, and LiNi₁₋ₓCoₓO₂, said doped materials being doped with an ion selected from Mg²⁺, Al³⁺, Ti⁴⁺, Zr⁴⁺, Nb⁶⁺, and W⁶⁺ in the lithium site at a concentration of 1 at % or less.

9. The composite of claim 1, wherein the entanglement comprises a structure in which the carbon nanotubes connect the aggregates while encompassing the exterior of the nanoparticle aggregates.

10. The composite of claim 9, wherein the entanglement further comprises a structure in which at least some of the carbon nanotube strands are comprised within the interior of the nanoparticle aggregates to connect the aggregates.

11. A lithium secondary battery, comprising:
a current collector; and
an electrode formed on the current collector,
wherein the electrode comprises the composite of electrode active material of claim 1.

12. A method of fabricating a composite of electrode active material, the method comprising:
(a) preparing a dispersion of electrode active material nanoparticles and a dispersion of carbon nanotubes;
(b) electrospraying the dispersions on a current collector, either separately or in combination, to form a composite of electrode active material as a network of a self-assembled aggregate of electrode active material and the carbon nanotubes; and
(c) subjecting the composite of electrode active material formed on the current collector to a heat treatment.

13. The method of claim 12, further comprising, after operation (b),
(b′) pressing the composite of electrode active material.

14. The method of claim 12, wherein the dispersion of electrode active material nanoparticles is obtained by performing a microbead milling on the electrode active material nanoparticles in a solvent for dispersion.

15. The method of claim 14, wherein the microbead milling is performed using microbeads with an average diameter of about 0.1 mm or less.

16. The method of claim 12, wherein the weight ratio of the solvent with a boiling point of about 80° C. or less in the dispersion is about 50% or more based on the total weight of the solvent.

17. The method of claim 12, wherein the electrospraying in (b) is controlled so as to achieve in the composite to be formed, a content for the carbon nanotubes of about 0.01 to about 20 parts by weight based on 100 parts by weight of the electrode active material nanoparticles.

18. The method of claim 12, wherein the electrospraying of the electrode active material nanoparticles is performed by applying a voltage of about 8 to about 30 kV and controlling a dispensing rate of the injection nozzle in the range of about 10 μL/min to about 300 μL/min for a time period until the thickness of the composite layer of electrode active material reaches about 500 nm to about 50 μm.

19. The method of claim 12, wherein the electrospraying is performed by simultaneous spraying from a plurality of nozzles composed of at least one injection nozzle comprising the dispersion of electrode active material nanoparticles and at least one injection nozzle comprising the dispersion of carbon nanotubes.

20. The method of claim 12, wherein the electrospraying is performed by spraying a dispersion in which the dispersion of electrode active material nanoparticles and the dispersion of carbon nanotubes are mixed.
